(19) United States
(12) Patent Application Publication
(10) Pub. No.: US 2014/0177872 A1
(43) Pub. Date: Jun. 26, 2014

(54) FREQUENCY CHARACTERISTICS DETERMINATION DEVICE

(71) Applicant: Onkyo Corporation, Osaka (JP)

(72) Inventor: Teppei SHIMIZU, Osaka (JP)

(73) Assignee: Onkyo Corporation, Osaka (JP)

(21) Appl. No.: 14/132,264

(22) Filed: Dec. 18, 2013

(30) Foreign Application Priority Data
Dec. 26, 2012 (JP) 2012-283022

(51) Int. Cl. H04R 3/04

(52) U.S. Cl. CPC H04R 3/04
USPC 381/103

(57) ABSTRACT

A frequency characteristics determination device that can prevent generation of a frequency response curve having an unnatural shape is provided. A CPU 11 sets pass points Pᵢ and Pᵢ₊₁ through which the frequency response curve of an audio signal should pass. Pᵢ₊₁ of a frequency Xₚᵢ₊₁ which is higher than a frequency Xₚᵢ of the pass point Pᵢ. The CPU 11 determines a direction point aᵢ of a Bezier curve Cᵢ for connecting the pass points Pᵢ and Pᵢ₊₁ based on the pass points Pᵢ and Pᵢ₊₁. The CPU 11 determines whether a frequency Xₐᵢ of the direction point aᵢ is within a reference range between not less than the frequency Xₚᵢ and not more than the frequency Xₚᵢ₊₁. When the frequency Xₐᵢ is out of the reference range, the CPU 11 moves the direction point aᵢ so that the frequency Xₐᵢ is within the reference range.

### BACKGROUND OF THE INVENTION

1. Field of the Invention

The present invention relates to a frequency characteristics determination device, and more specifically, relates to the frequency characteristics determination device for determining a frequency response curve of an audio signal.

2. Description of the Related Art

Equalizers change sound quality of audio signals according to predetermined frequency response curves. The equalizers contain a frequency characteristics determination device for determining frequency characteristics of audio signals, and use a frequency response curve determined by a frequency characteristics determination device.

Various methods for determining frequency characteristics are present. For example, a method for dividing an audio signal into a plurality of frequency bands, and determining a gain for each of the divided frequency bands is present.

Further, Japanese Unexamined Patent Application Publication No. 2011-517390 discloses a method for generating a curve that connects points specified by a user, and using the generated curve as a frequency response curve. In the invention of Japanese Unexamined Patent Application Publication No. 2011-517390, a plane where a frequency is set along an abscissa axis and a gain is set along an ordinate axis is displayed on a display. The user specifies desired points on the displayed plane. A curve that smoothly connects the specified points is automatically generated. An equalizer uses the generated curve as a frequency response curve.

In Japanese Unexamined Patent Application Publication No. 2011-517390, the frequency response curve is generated based on a frequency response of a shelving filter. Japanese Patent No. 4132693 discloses an equalizer for connecting specified points using spline interpolation so as to generate a frequency response curve.

A frequency characteristics determination device can generate a curve for smoothly connecting a plurality of specified points using a Bezier curve, and determine this curve as a frequency response curve. However, when the frequency response curve is generated by using the Bezier curve, the generated frequency response curve occasionally has an unnatural shape. For example, a generated frequency response curve occasionally draws a loop or an extremely large peak.

When the frequency response curve draws a loop, gains cannot be uniquely specified for a certain frequency. Further, when a frequency response curve draws an extremely large peak, an audio with a frequency related to the peak is enhanced beyond expectation, and an audio signal cannot be changed into one with a sound quality intended by a user.

### SUMMARY OF THE INVENTION

It is an object of the present invention to provide a frequency characteristics determination device that can prevent generation of a frequency response curve having an unnatural shape.

A frequency characteristics determination device comprising: a setting section for setting a first pass point through which a frequency response curve of an audio signal should pass, and a second pass point whose frequency is higher than a frequency of the first pass point; a determination section for determining one or more direction points of a Bezier curve connecting the set first and second pass points based on the set first and second pass points; a range determination section for determining whether frequencies of the one or more direction points determined by the determination section are within a range between not less than the frequency of the first pass point and not more than the frequency of the second pass point; a moving section for moving the one or more direction points so that frequencies of the direction points are within the range when the determination is made that the frequencies of the direction points are out of the range; a generation section for generating a Bezier curve based on the one or more direction points and the first and second pass points; and a changing section for changing the frequency response curve of the audio signal according to the Bezier curve generated by the generation section.

According to the present invention, one or more direction points of a Bezier curve connecting first and second pass points are present within a range of not less than a frequency of the first pass point to not more than a frequency of the second pass point. As a result, when frequency response curve of an audio signal is determined by using a Bezier curve, the frequency response curve can be prevented from having an unnatural shape.

Preferably, wherein the one or more direction points include first and second direction points, the range determination section determines whether each of the first and second direction points is within the range.

According to the present invention, a frequency response curve of an audio signal can be determined by using three or more Bezier curves.

Preferably, wherein a first tangent of the Bezier curve at the first pass point passes through the first direction point, a second tangent of the Bezier curve at the second pass point passes through the second direction point, and the moving section moves the first direction point along the first tangent, and moves the second direction point along the second tangent.

According to the present invention, a great change in the shape of the Bezier curve before and after first and second direction points can be suppressed.

Preferably, wherein when the frequency of the first direction point is lower than the frequency of the first pass point, the moving section makes the frequency of the first direction point match with the frequency of the first pass point, and when the frequency of the second direction point is lower than the frequency of the first pass point, the moving section makes the frequency of the second direction point match with the frequency of the first pass point, and when the frequency of the first direction point is higher than the frequency of the second pass point, the moving section makes the frequency of the first direction point match with the frequency of the second pass point, and when the frequency of the second direction point is higher than the frequency of the second pass point, the moving section makes the frequency of the second direction point match with the frequency of the second pass point.

According to the present invention, when the first or second direction point is moved, a moving amount of the first or second direction point can be suppressed.

Preferably, further comprising: a comparing section for comparing the frequency of the first direction point with the frequency of the second direction point, wherein when the comparing section determines that the frequency of the first direction point is higher than the frequency of the second direction point, the moving section moves at least one of the first and second direction points so that the frequency of the first direction point is not more than the frequency of the second direction point.

According to the present invention, since the frequency of the first direction point is not more than the frequency of the second direction point, a frequency response curve for enabling gains to be uniquely specified for the frequency can be generated.

A frequency characteristics determination device comprising: a setting section for setting a first pass point through which a frequency response curve of an audio signal should pass, and a second pass point whose frequency is higher than a frequency of the first pass point; a determination section for determining first and second direction points of a Bezier curve connecting the set first and second pass points based on the set first and second pass points; a comparing section for comparing a first frequency of the first direction point through which a tangent of the Bezier curve at the first pass point passes with a second frequency of the second direction point through which a tangent of the Bezier curve at the second pass point passes; a moving section for, when the comparing section determines that the first frequency is higher than the second frequency, moving at least one of the first and second direction points so that the first frequency is not more than the second frequency; a generation section for generating a Bezier curve based on the first and second pass points and the first and second direction points; and a changing section for changing the frequency response curve of the audio signal according to the Bezier curve generated by the generation section.

According to the present invention, at least one of the first and second direction points can be moved so that a first frequency is not more than a second frequency. As a result, when frequency response curve of an audio signal is determined by using a Bezier curve, the frequency response curve can be prevented from having an unnatural shape.

A recording medium in which a control program is stored, the control program allowing a computer installed into a frequency characteristics determination device to execute: a step of setting a first pass point through which a frequency response curve of an audio signal should pass and a second pass point whose frequency is higher than a frequency of the first pass point; a step of determining one or more direction points of a Bezier curve connecting the set first and second pass points based on the set first and second pass points; a step of determining whether frequencies of the determined one or more direction points are within a range between not less than the frequency of the first pass point and not more than the frequency of the second pass point; a step of moving the one or more direction points so that frequencies of the one or more direction points are within the range when the determination is made that the frequencies of the one or more direction points are out of the range; a step of generating a Bezier curve based on the one or more direction points and the first and second pass points; a step of changing the frequency response curve of the audio signal according to the generated Bezier curve.

According to the present invention, one or more direction points of a Bezier curve connecting first and second pass points are present within a range of not less than a frequency of the first pass point to not more than a frequency of the second pass point. As a result, when frequency response curve of an audio signal is determined by using a Bezier curve, the frequency response curve can be prevented from having an unnatural shape.

A recording medium in which a control program is stored, the control program allowing a computer installed into a frequency characteristics determination device to execute: a step of setting a first pass point through which a frequency response curve of an audio signal should pass and a second pass point whose frequency is higher than a frequency of the first pass point; a step of determining first and second direction points of a Bezier curve connecting the set first and second pass points based on the set first and second pass points; a step of comparing a first frequency of the first direction point through which a tangent of the Bezier curve at the first pass point passes with a second frequency of the second direction point through which a tangent of the Bezier curve at the second pass point passes; a step of, when a determination is made that the first frequency is higher than the second frequency, moving at least one of the first and second direction points so that the first frequency is not more than the second frequency; a step of generating a Bezier curve based on the first and second pass points and the first and second direction points; and a step of changing the frequency response curve of the audio signal according to the generated Bezier curve.

According to the present invention, at least one of the first and second direction points can be moved so that a first frequency is not more than a second frequency. As a result, when frequency response curve of an audio signal is determined by using a Bezier curve, the frequency response curve can be prevented from having an unnatural shape.

### BRIEF DESCRIPTION OF THE DRAWINGS

FIG. 1 is a functional block diagram illustrating a constitution of a tablet terminal according to an embodiment of the present invention;

FIG. 2 is a diagram illustrating a setting screen to be displayed on a touch panel shown in FIG. 1;

FIG. 3 is a flowchart of a frequency characteristics determination program shown in FIG. 1;

FIG. 4 is a diagram describing a principle that the Bezier curve shown in FIG. 2 is generated;

FIG. 5 is a graph illustrating one example of the Bezier curve shown in FIG. 3 that is drawn without executing direction point adjustment processing;

FIG. 6 is a graph illustrating another example of the Bezier curve shown in FIG. 3 that is drawn without executing the direction point adjustment processing;

FIG. 7 is a flowchart of the direction point adjustment processing shown in FIG. 3;

FIG. 8 is a flowchart of pass point reference processing shown in FIG. 7;

FIG. 9 is a diagram illustrating one example of the Bezier curve show in FIG. 7 before the pass point reference processing is executed;

FIG. 10 is a diagram illustrating another example of the Bezier curve shown in FIG. 7 before the pass point reference processing is executed;

FIG. 11 is a diagram illustrating another example of the Bezier curve shown in FIG. 7 before the pass point reference processing is executed;

FIG. 12 is a diagram illustrating another example of the Bezier curve shown in FIG. 7 before the pass point reference processing is executed;

FIG. 13 is a diagram illustrating one example of the Bezier curve shown in FIG. 7 before intersection reference processing is executed;

FIG. 14 is a flowchart of the intersection reference processing shown in FIG. 7;

FIG. 15 is a graph illustrating the Bezier curve after direction points are moved in the graph shown in FIG. 5; and

FIG. 16 is a graph illustrating the Bezier curve after the direction points are moved in the graph shown in FIG. 6.

### DETAILED DESCRIPTION OF THE PREFERRED EMBODIMENTS

An embodiment of the present invention is described in detail below with reference to the drawings. The same or corresponding parts in the drawings are denoted by the same symbols, and description thereof is not repeated.

{1. Constitution of Tablet Terminal}

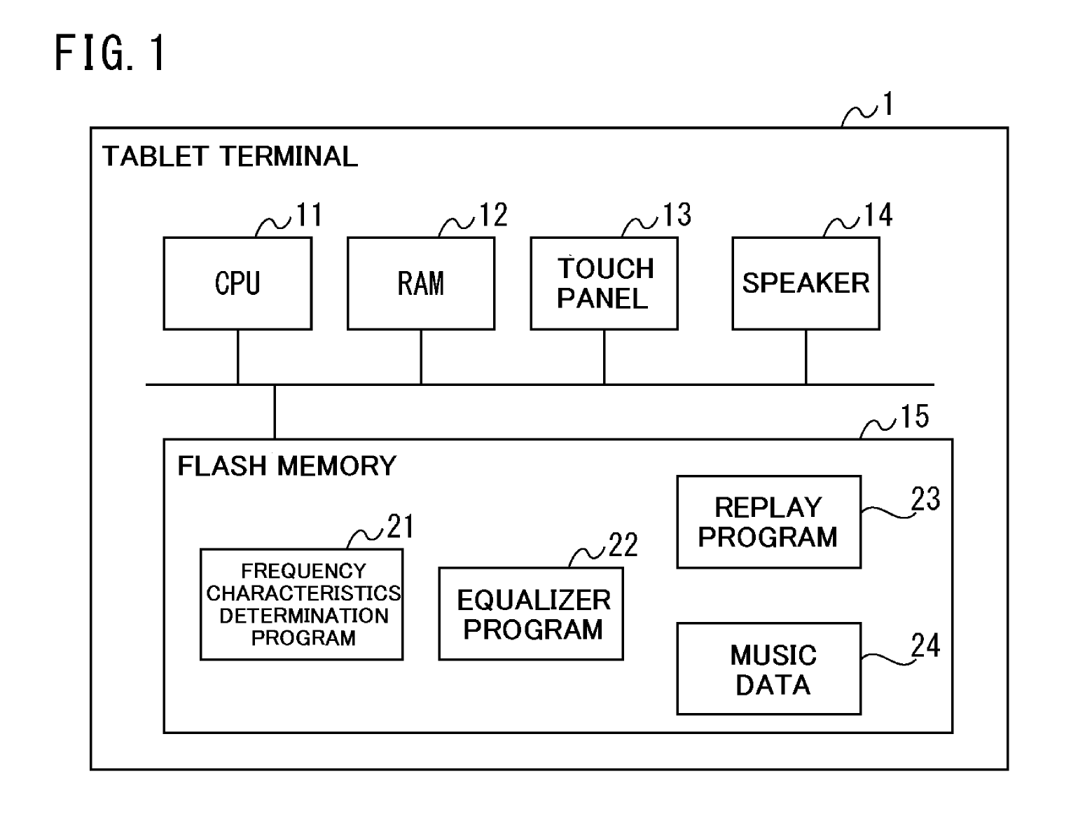

FIG. 1 is a functional block diagram illustrating a constitution of a tablet terminal 1 according to the embodiment of the present invention. In FIG. 1, the tablet terminal 1 is a computer that operates as a frequency characteristics determination device when a frequency characteristics determination program 21 is installed. In the embodiment, the frequency characteristics determination device determines a frequency response curve of an audio signal. The frequency response curve is used when an equalizer changes a sound quality of an audio signal.

The tablet terminal 1 includes a CPU (Central Processing Unit) 11, a RAM (Random Access Memory) 12, a touch panel 13, a speaker 14, and a flash memory 15.

The CPU 11 loads various programs stored in the flash memory 15 into the RAM 12, and executes the loaded programs so as to control the tablet terminal 1. The RAM 12 is a main memory of the tablet terminal 1.

The touch panel 13 displays a setting screen for a frequency response curve of an audio signal. The touch panel 13 outputs a position touched by a user as operation information.

The speaker 14 outputs an audio signal that is reproduced by the tablet terminal 1 as an audio.

The flash memory 15 is a non-volatile semiconductor memory, and stores the frequency characteristics determination program 21 (hereinafter, referred to as “the determination program 21”), an equalizer program 22, a replay program 23, and music data 24.

The music data 24 is an audio signal that is compressed by an MP3 (MPEG Audio Layer-3) system. An audio signal compression system may be one other than MP3. The replay program 23 is a program for decoding the music data 24 so as to generate an audio signal. The equalizer program 22 is a program for changing a sound quality of an audio signal generated by the replay program 23 based on the frequency response curve determined by the determination program 21. The determination program 21 is a program for generating a frequency response curve according to user's operations. Details of the determination program 21 will be described later.

FIG. 1 illustrates the determination program 21, the equalizer program 22, and the replay program 23 as independent programs, but the present invention is not limited to this. For example, the determination program 21 may be included in the equalizer program 22. The determination program 21 and the equalizer program 22 may be included in the replay program 23.

{2. Outline of the Frequency Characteristics Determination Program 21}

The determination program 21 is a program for generating a Bezier curve that passes through pass points set by the user, and determining the frequency response curve of the audio signal using the Bezier curve.

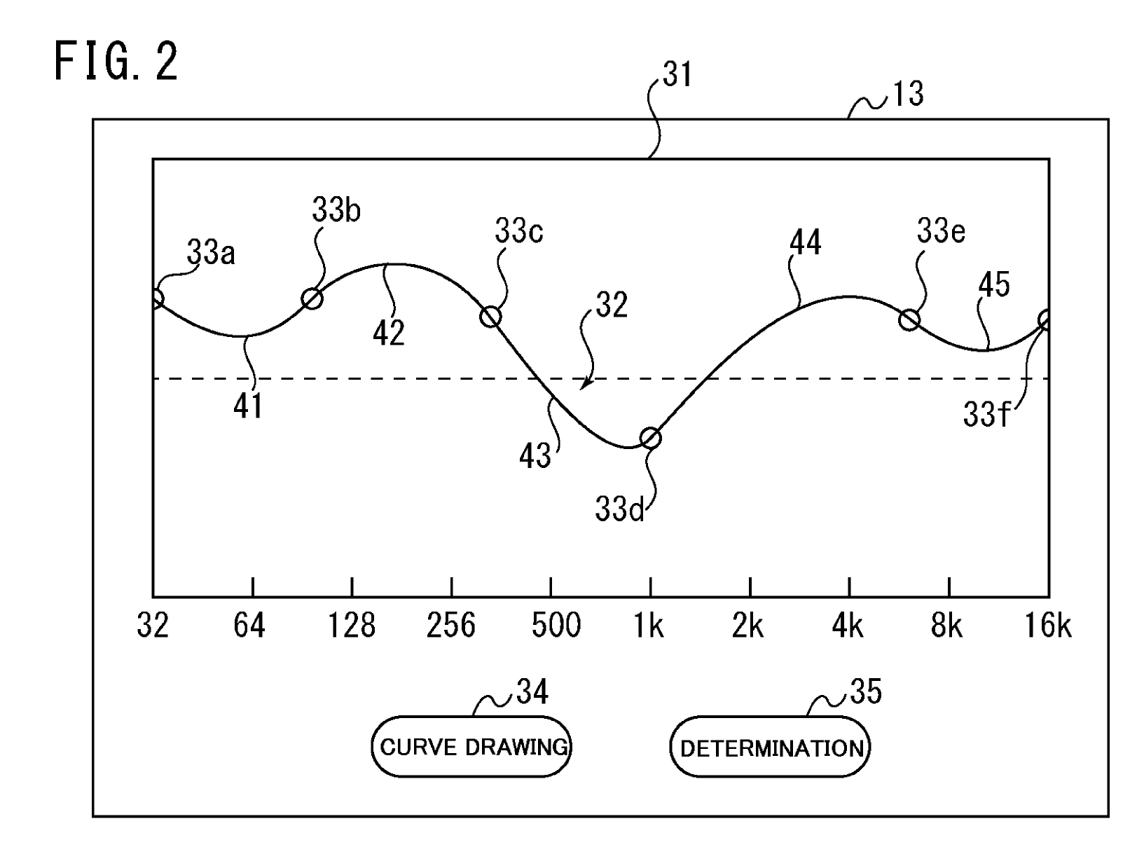

FIG. 2 is a diagram illustrating a setting screen 31 of the frequency response curve to be displayed on the touch panel 13. The CPU 11 runs the determination program 21 so as to display the setting screen 31 on the touch panel 13 as shown in FIG. 2. When the setting screen 31 is first displayed on the touch panel 13, a frequency response curve 32 is not displayed on the setting screen 31. The user touches a plurality of desired positions on the displayed setting screen 31. The touched positions are set as pass points 33a to 33f through which the frequency response curve 32 should pass.

The CPU 11 generates a Bezier curve for connecting adjacent two pass points. Concretely, a Bezier curve 41 for connecting the pass points 33a and 33b, a Bezier curve 42 for connecting pass points 33b and 33c, a Bezier curve 43 for connecting pass points 33c and 33d, a Bezier curve 44 for connecting pass points 33d and 33e, and a Bezier curve 45 for connecting pass points 33e and 33f are generated. The Bezier curves 41 to 45 are essentially generated so as to smoothly connect the pass points. The frequency response curve of an audio signal is changed based on the generated Bezier curves 41 to 45.

{3. Operation of the Frequency Characteristics Determination Program 21}

An operation of the tablet terminal 1 for running the determination program 21 will be described in detail below.

{3.1. Basic Flow}

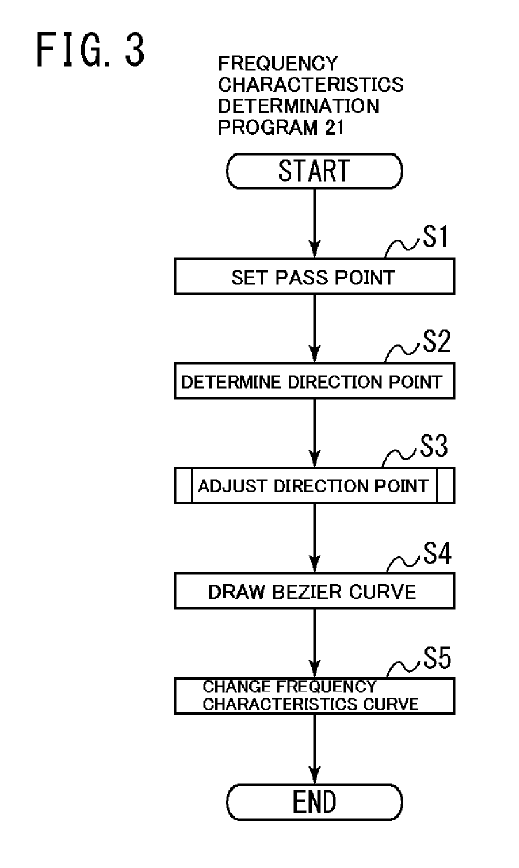

FIG. 3 is a flowchart illustrating the operation of the tablet terminal 1 for running the determination program 21. The CPU 11 displays the setting screen 31 on the touch panel 13, and accepts setting of the pass points (step S1) as shown in FIGS. 2 and 3. The CPU 11 determines direction points of a third Bezier curve for connecting the adjacent two pass points (step S2). The direction points are points through which a tangent of the Bezier curve at the pass points passes. Hereinafter, the third Bezier curve is simply referred to as “Bezier curve” unless otherwise noted. Details of step S2 will be described later.

The CPU 11 adjusts the positions of the direction points determined at step S2 (step S3). In the frequency response curve determined based on the Bezier curve, gains cannot be uniquely determined for a frequency in some cases. The CPU 11 adjusts the positions of the direction point and changes the shape of the Bezier curve in order to enable the gains to be uniquely determined. Details of step S3 will be described later.

When a curve drawing button 34 is touched by the user, the CPU 11 generates the Bezier curves 41 to 45 using the pass points and the direction points whose positions are adjusted so as to draw it on the setting screen 31 (step S4). When the drawn Bezier curves 41 to 45 are used as the frequency response curve, the user touches a determination button 35. The CPU 11 determines a curve that connects the generated Bezier curves 41 to 45 as a new frequency response curve 32, so as to change the frequency response curve 32 (step S5).

When the user desires to correct the shapes of the drawn Bezier curves 41 to 45, the user may set the pass points again (step S1). The user can move the positions of the pass points on the setting screen 31, or can add new pass points. In this case, the CPU 11 repeats the processing at steps S2 to S4 so as to draw a new Bezier curve.

{3.2. Determination of Direction Point (step S2)}

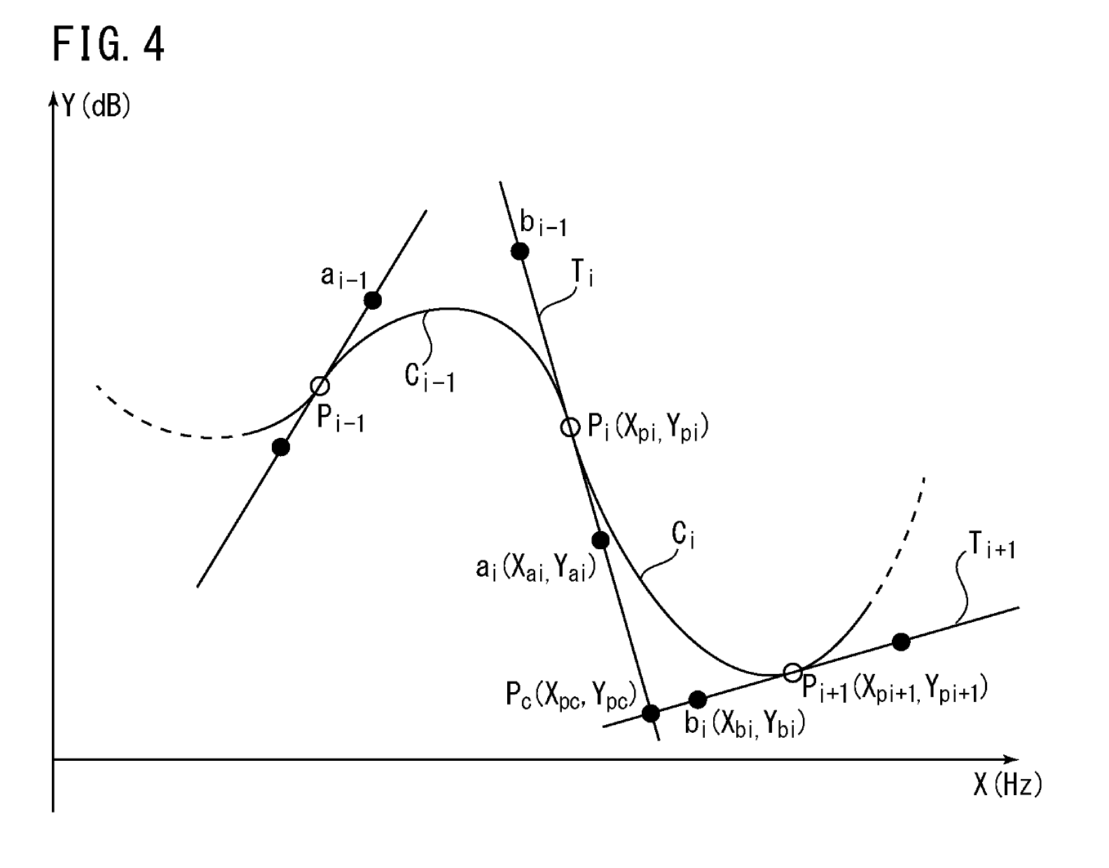

FIG. 4 is a diagram describing a principle that the Bezier curve for connecting the adjacent two pass points is generated. In FIG. 4, an abscissa axis represents a frequency, and an ordinate axis represents a gain. It is assumed that n (n: an integer of 2 or more) -numbered pass points Pᵢ are already set as shown in FIG. 4. “i” denotes a natural number of 1 or more to n−1 or less. The pass points P₁, P₂, . . . , Pₙ are set in increasing order of the frequency.

A Bezier curve Cᵢ₋₁ connects the pass point Pᵢ₋₁ and the pass point Pᵢ that are adjacent to each other. A Bezier curve Cᵢ connects the pass point Pᵢ and the pass point Pᵢ₊₁ that are adjacent to each other. The CPU 11 determines the direction points such that the Bezier curve Cᵢ smoothly joints to Bezier curve Cᵢ₊₁ at step S2.

When the Bezier curves Cᵢ₋₁ and Cᵢ smoothly connect to each other at the pass point Pᵢ, the Bezier curves Cᵢ₋₁ and Cᵢ are C2 continuous, and satisfy the following formulas (1) and (2):

$$\begin{matrix}Mathematical Formula 1 & \\ \frac{d {C}_{i - 1} ( 1 )}{d t} = \frac{d {C}_{i} ( 0 )}{d t} & ( 1 ) \\ Mathematical Formula 2 & \\ \frac{{d}^{2} {C}_{i - 1} ( 1 )}{d {t}^{2}} = \frac{{d}^{2} {C}_{i} ( 0 )}{d {t}^{2}} & ( 2 )\end{matrix}$$

“C2 continuous” means that values obtained by two differentials are continuous. In the formulas (1) and (2), Cᵢ₋₁ and Cᵢ are expressed as a function of t. “t” denotes a variable of 0 or more to 1 or less. Cᵢ₋₁(1) denotes an end point (the pass point Pᵢ) of the Bezier curve Cᵢ₋₁(0) denotes a start point (the pass point Pᵢ) of the Bezier curve Cᵢ. The formula (1) indicates that a tilt of a tangent at the end point in the Bezier curve Cᵢ₋₁ matches with a tilt of a tangent at the start point of the Bezier curve Cᵢ. The formula (2) indicates that a curvature at the end point of the Bezier curve Cᵢ₋₁ matches with a curvature at the start point of the Bezier curve Cᵢ.

According to the characteristics of the third Bezier curve, Cᵢ₋₁(t) and Cᵢ(t) satisfy the following formulas (3) to (6):

$$\begin{matrix}Mathematical Formula 3 & \\ \frac{d {C}_{i} ( 0 )}{d t} = 3 \cdot ( {a}_{i} - {P}_{i} ) & ( 3 ) \\ Mathematical Formula 4 & \\ \frac{d {C}_{i - 1} ( 1 )}{d t} = 3 \cdot ( {P}_{i} - {b}_{i - 1} ) & ( 4 ) \\ Mathematical Formula 5 & \\ \frac{{d}^{2} {C}_{i} ( 0 )}{d {t}^{2}} = 6 \cdot ( {b}_{i} - 2 {a}_{i} + {P}_{i} ) & ( 5 ) \\ Mathematical Formula 6 & \\ \frac{{d}^{2} {C}_{i - 1} ( 1 )}{d {t}^{2}} = 6 \cdot ( {P}_{i} - 2 {b}_{i - 1} + {a}_{i - 1} ) & ( 6 )\end{matrix}$$

In the formulas (3) to (6), aᵢ and bᵢ denote the direction points of the Bezier curve Cᵢ. The direction point aᵢ determines the direction of a tangent at the pass point Pᵢ (start point) of the Bezier curve Cᵢ. The direction point bᵢ determines the direction of a tangent at the pass point Pᵢ₊₁ (the end point) of the Bezier curve Cᵢ.

When the formulas (3) to (6) are solved, the following formulas (7) and (8) can be obtained:

Mathematical Formula 7

3·(aᵢ−Pᵢ)=3·(Pᵢ−bᵢ₋₁) (7)

Mathematical Formula 8

6·(bᵢ−2aᵢ+Pᵢ)=6·(Pᵢ−2bᵢ₋₁+aᵢ₋₁) (8)

When the formulas (7) and (8) are solved, the following formulas (9) and (10) can be obtained:

Mathematical Formula 9

aᵢ+bᵢ₋₁=2Pᵢ (9)

Mathematical Formula 10

−2bᵢ₋₁+aᵢ₋₁−bᵢ+2aᵢ=0 (10)

The direction points a₁, a₂, . . . , aₙ₋₁, and the direction points b₁, b₂, . . . , bₙ₋₁ that satisfy the formulas (9) and (10) are acquired, so that the direction points that smoothly connect the Bezier curve C₁ to Cₙ₋₁ are determined. In order to solve the formulas (9) and (10), a condition such that secondary differentiations at the pass points P₁ and Pₙ at both the ends are 0 is added. This condition is represented by the following formulas (11) and (12):

Mathematical Formula 11

b₁−2a₁+Pᵢ=0 (11)

Mathematical Formula 12

Pₙ−2bₙ₋₁−aₙ₋₁=0 (12)

{3.3. Adjustment of Direction Points (step S3)}

The CPU 11 adjusts the positions of the direction points determined at step S2 (step S3). A reason why the positions of the direction points are adjusted will be described.

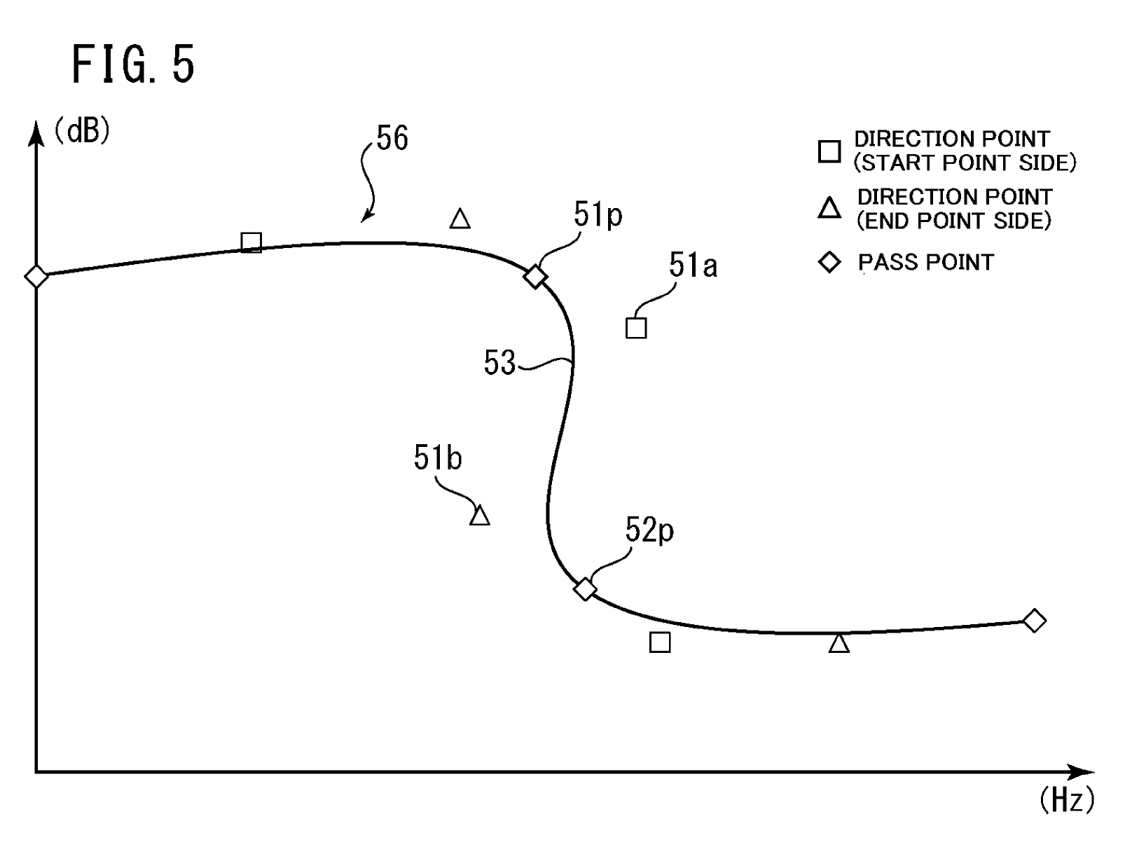

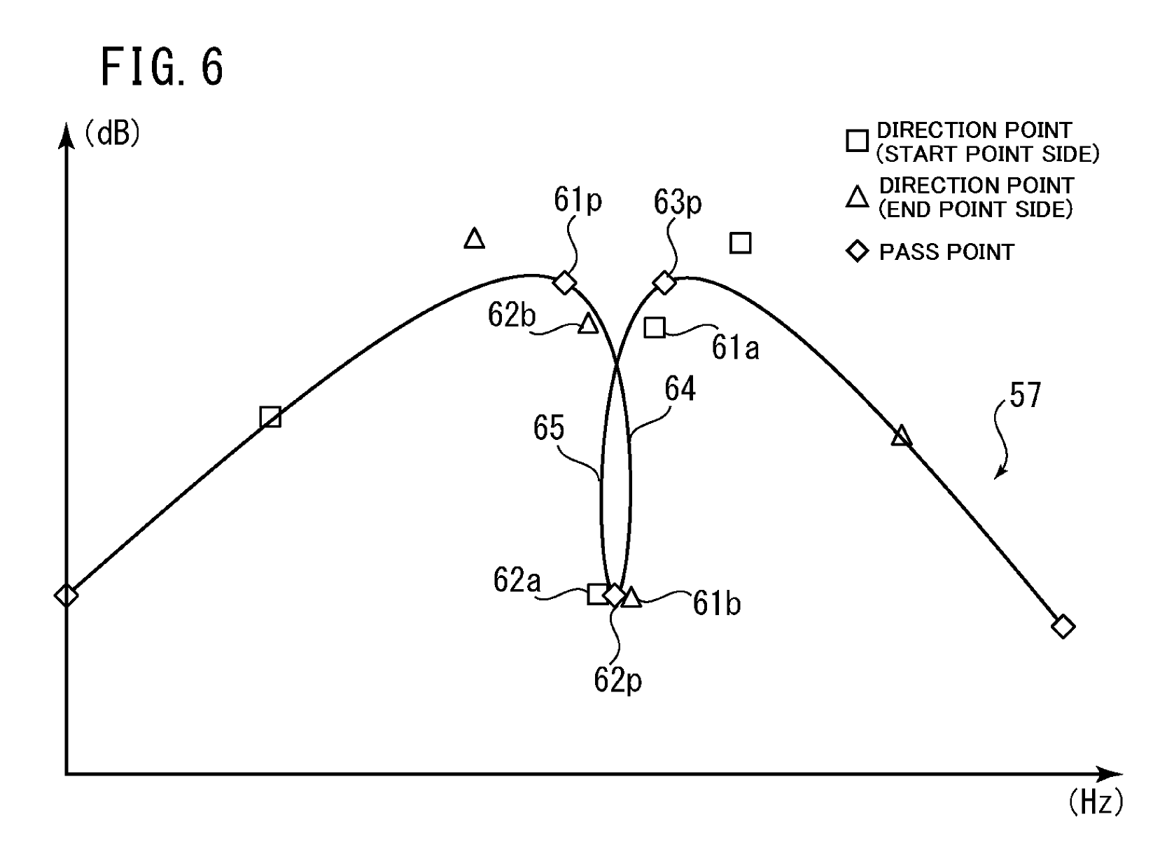

FIGS. 5 and 6 are diagrams illustrating Bezier curves generated based on the direction points before the positions are adjusted. A Bezier curve 53 that connects pass points 51p and 52p has an S shape as shown in FIG. 5. A Bezier curve 64 connects pass points 61p and 62p, and a Bezier curve 65 connects pass points 62p and 63p as shown in FIG. 6. The Bezier curves 64 and 65 draw a spiral. A frequency region where the gains of an audio signal cannot be uniquely specified is present in a frequency response curve 56 including the Bezier curve 53, and a frequency response curve 57 including the Bezier curves 64 and 65. Direction points 51a, 51b, 61a, 61b, 62a, and 62b will be described later.

Therefore, the CPU 11 moves the direction points that satisfy a predetermined condition so that the positions of the direction points are adjusted. As a result, even when a Bezier curve is used, a frequency response curve for enabling gains to be uniquely specified can be drawn.

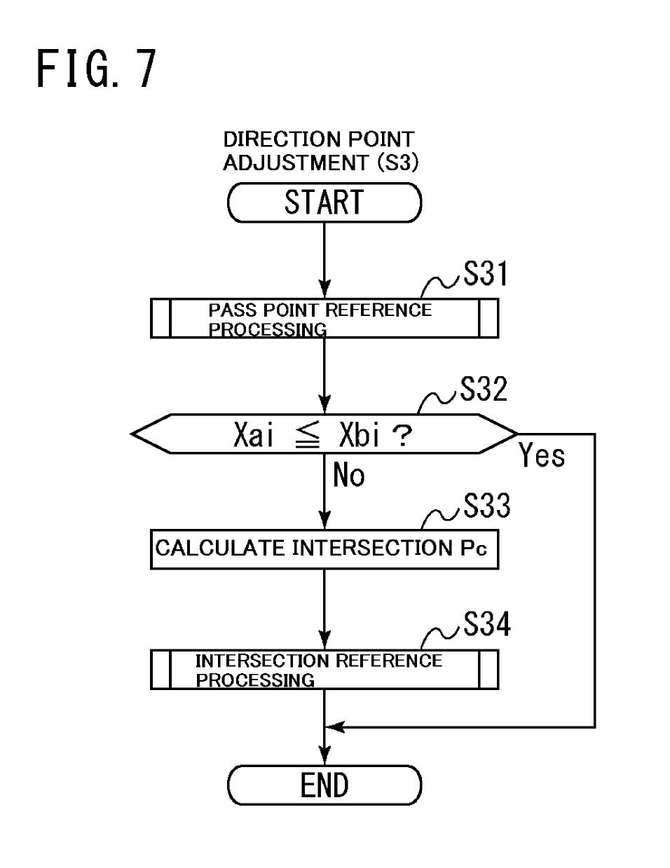

FIG. 7 is a flowchart of a direction point adjustment processing (step S3) shown in FIG. 3. The CPU 11 executes a processing at steps S31 to S34 for each of the Bezier curves Cᵢ as shown in FIG. 7.

The CPU 11 executes pass point reference processing for adjusting the positions of the direction points aᵢ and bᵢ based on the positions of the pass points Pᵢ and Pᵢ₊₁ as shown in FIGS. 4 and 7 (step S31). The direction points aᵢ and bᵢ are moved within a reference range by the pass point reference processing. The reference range means the frequency or more of the start point (the pass point Pᵢ) of the Bezier curve Cᵢ to the frequency or less of the end point (the pass point Pᵢ₊₁) of the Bezier curve Cᵢ. Details of the pass point reference processing (step S31) will be described later.

The CPU 11 compares a frequency Xₐᵢ of the direction point aᵢ with a frequency X_{bi} of the direction point bᵢ (step S32). When the frequency Xₐᵢ is the frequency X_{bi} or less (Yes at step S32), the CPU 11 ends the direction point adjustment processing (step S3).

On the other hand, when the frequency Xₐᵢ is higher than the frequency X_{bi} (No at step S32), the CPU 11 calculates an intersection P_{c} between a tangent Tᵢ of the Bezier curve Cᵢ at the direction point aᵢ and a tangent Tᵢ₊₁ of the Bezier curve Cᵢ at the direction point bᵢ (step S33). When the direction points aᵢ and bᵢ move in the pass point reference processing (step S31), the moved direction points aᵢ and bᵢ are used for the calculation of the intersection P_{c}. The CPU 11 executes intersection reference processing (step S34) for adjusting the positions of the direction points aᵢ and bᵢ according to the position of the intersection P_{c}. Details of the intersection reference processing (step S34) will be described later.

{3.4. Pass Point Reference Processing (step S31)}

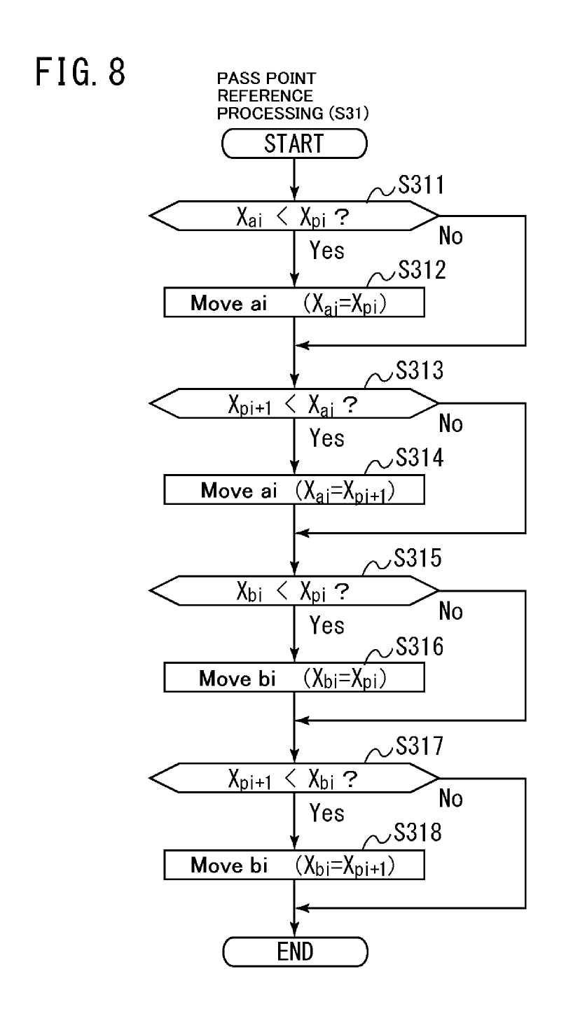

FIG. 8 is a flowchart of the pass point reference processing (step S31). The CPU 11 executes steps S311 to S314 as shown in FIGS. 4 and 8, and moves the direction point aᵢ so that the direction point aᵢ is within the reference range.

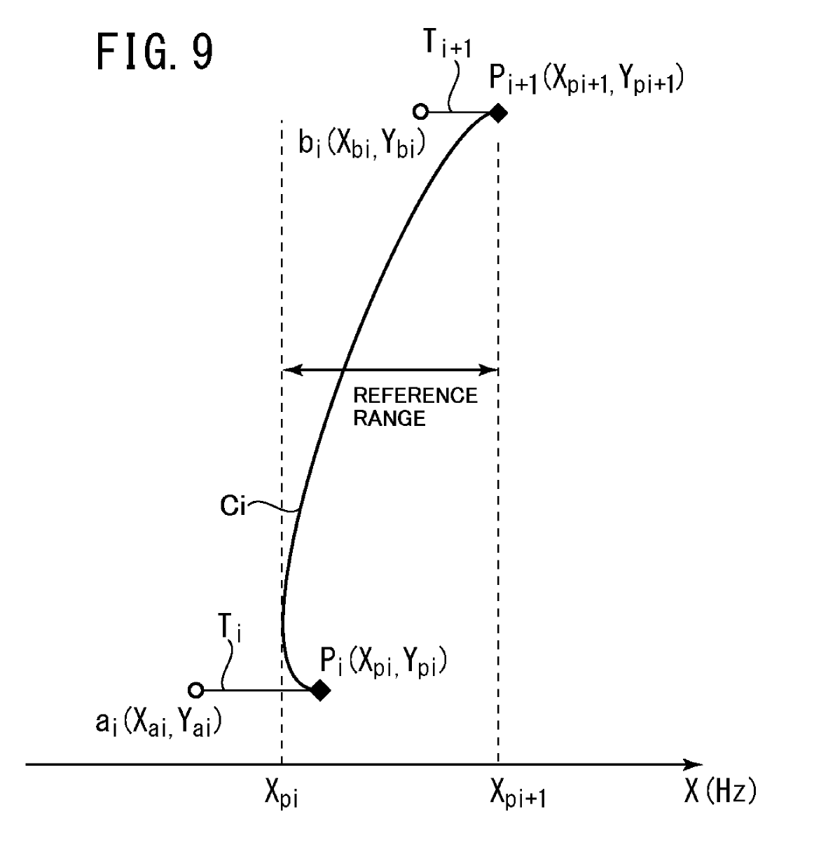

FIG. 9 is a diagram illustrating the Bezier curve Cᵢ in a case where the frequency Xₐᵢ of the direction point aᵢ is lower than the frequency Xₚᵢ of the pass point Pᵢ. When the frequency Xₐᵢ is lower than the frequency Xₚᵢ (Yes at step S311), the Bezier curve Cᵢ passes through a region of the frequency lower than the frequency Xₚᵢ as shown in FIGS. 8 and 9. This causes a frequency response curve to have a loop shape. The CPU 11 moves the direction point aᵢ in the direction of the tangent Tᵢ, and makes the frequency Xₐᵢ match with the frequency Xₚᵢ (step S312). As a result, the Bezier curve Cᵢ is prevented from passing through a region where the frequency is lower than the frequency Xₚᵢ.

On the other hand, when the frequency Xₐᵢ is not less than the frequency Xₚᵢ (No at step S311), the CPU 11 proceeds to step S313.

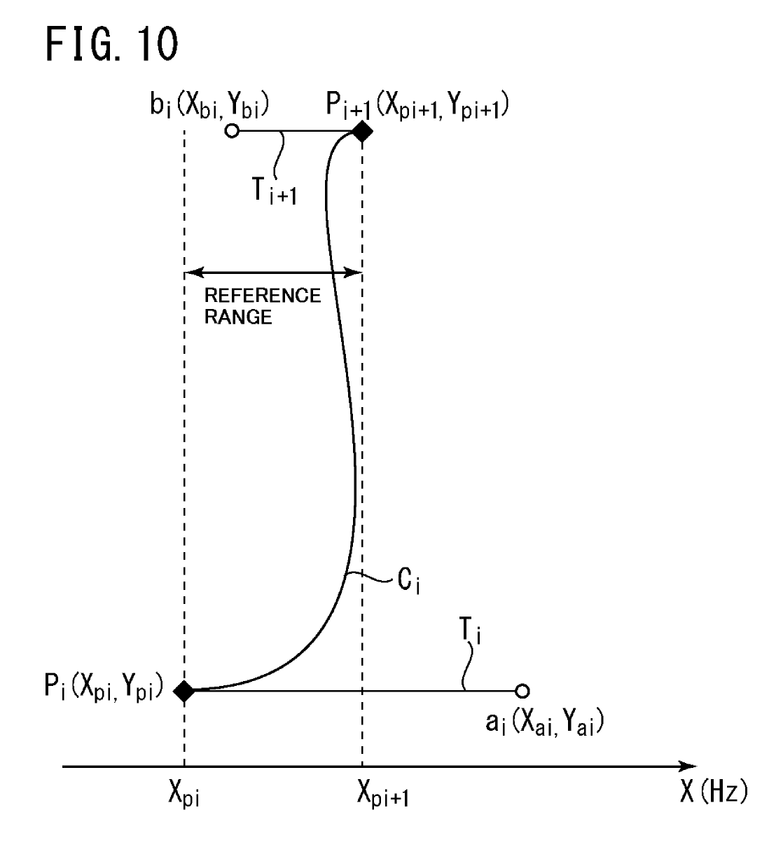

FIG. 10 is a diagram illustrating the Bezier curve Cᵢ in a case where the frequency Xₐᵢ of the direction point aᵢ is higher than a frequency Xₚᵢ₊₁ of the pass point Pᵢ₊₁. When the frequency Xₐᵢ is higher than the frequency Xₚᵢ₊₁ (Yes at step S313) as shown in FIGS. 8 and 10, a plurality of gains is related to one frequency on the Bezier curve Cᵢ. In this case, the CPU 11 moves the direction point aᵢ to the direction of the tangent Tᵢ, so as to make the frequency Xₐᵢ match with the frequency Xₚᵢ₊₁ (step S314). As a result, the gains can be uniquely specified on the Bezier curve Cᵢ.

On the other hand, when the frequency Xₐᵢ is not more than the frequency Xₚᵢ₊₁ (No at step S313), the CPU 11 proceeds to step S315.

When the direction point aᵢ is present within the reference range (No at step S311, No at step S313), the CPU 11 does not move the direction point aᵢ.

The CPU 11, then, executes steps S315 to S318, and moves the direction point bᵢ so that the direction point bᵢ is within the reference range.

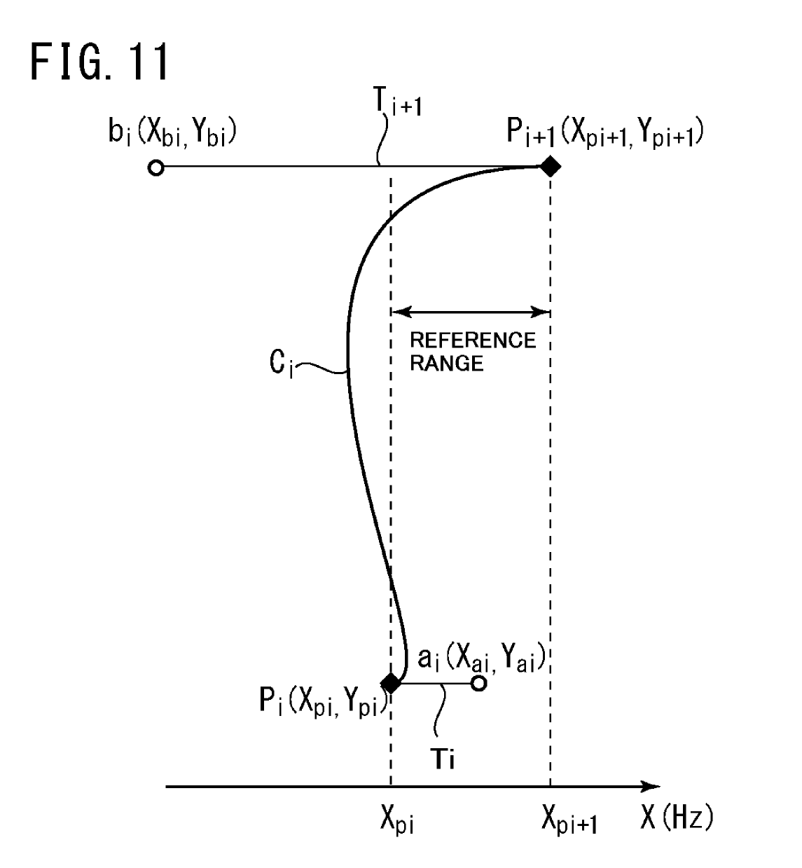

FIG. 11 is a diagram illustrating the Bezier curve Cᵢ in a case where the frequency X_{bi} of the direction point bᵢ is lower than the frequency Xₚᵢ of the pass point Pᵢ. When the frequency X_{bi} is lower than the frequency Xₚᵢ (Yes at step S315), a plurality of gains is related to one frequency on the Bezier curve Cᵢ as shown in FIGS. 8 and 11. In this case, the CPU 11 moves the direction point bᵢ to the direction of the tangent Tᵢ₊₁, so as to make the frequency X_{bi} match with the frequency Xₚᵢ (step S316).

On the other hand, when the frequency X_{bi} is not less than the frequency Xₚᵢ (No at step S315), the CPU 11 proceeds to step S317.

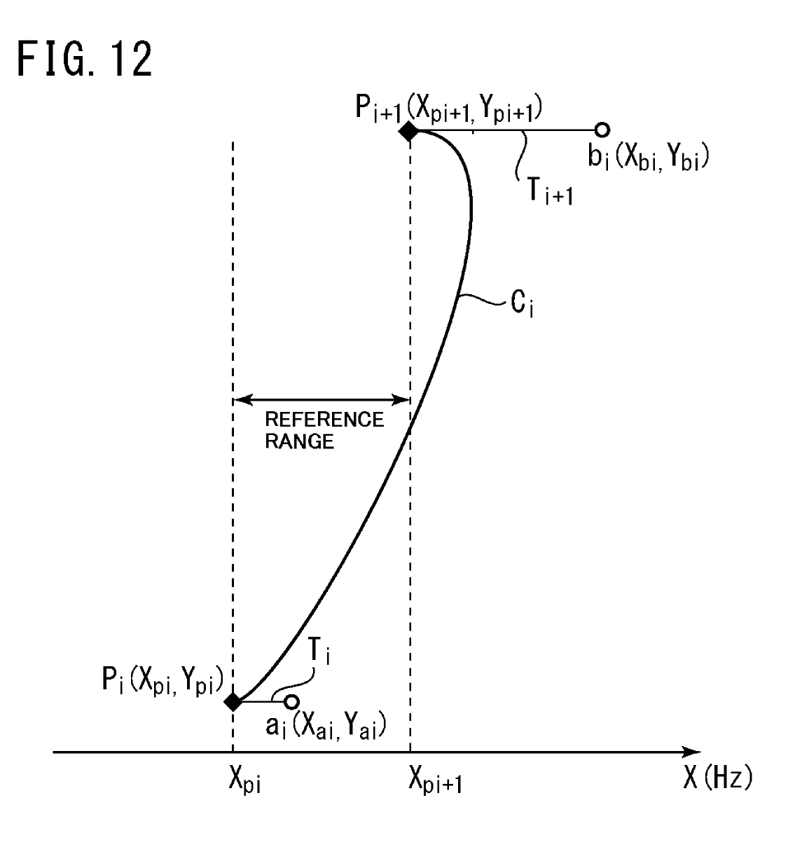

FIG. 12 is a diagram illustrating the Bezier curve Cᵢ in the case where frequency X_{bi} of the direction point bᵢ is higher than the frequency Xₚᵢ₊₁ of the pass point Pᵢ₊₁. When the frequency X_{bi} is higher than the frequency Xₚᵢ₊₁ (Yes at step S317), the Bezier curve Cᵢ passes through a region of the frequency higher than the frequency Xₚᵢ₊₁ as shown in FIGS. 8 and 11. This causes a frequency response curve to have a loop shape. The CPU 11 moves the direction point bᵢ to the direction of the tangent Tᵢ₊₁, so as to make the frequency X_{bi} to match with the frequency Xₚᵢ₊₁ (step S318).

On the other hand, when the frequency X_{bi} is not more than the frequency Xₚᵢ₊₁ (No at step S317), the CPU 11 ends the pass point reference processing (step S31).

When the direction point bᵢ is present within the reference range (No at step S315, No at step S317), the CPU 11 does not move the direction point bᵢ.

In such a manner, when a determination is made that the direction point aᵢ is out of the reference range, the CPU 11 moves the direction point aᵢ to the direction of the tangent Tᵢ so that the direction point aᵢ is within the reference range. The similar processing is executed also on the direction point bᵢ. The movement of the direction points aᵢ and bᵢ to the direction of the tangent can prevent the shape of the Bezier curve Cᵢ from greatly changing before and after the movement of the direction points aᵢ and bᵢ.

Further, the frequency Xₐᵢ of the direction point aᵢ is made to match with any one of the frequencies Xₚᵢ and Xₚᵢ₊₁, so that a moving amount of the direction point aᵢ can be suppressed. Much the same is true on the direction point bᵢ. As a result, the shape of the Bezier curve Cᵢ can be prevented from greatly changing before and after the movement of the direction points aᵢ and bᵢ.

{3.5. The Intersection Reference Processing (step S34)}

When the frequency Xₐᵢ of the direction point aᵢ is higher than the frequency X_{bi} of the direction point bᵢ (No at step S32), the CPU 11 executes the intersection reference processing (step S34) as shown in FIG. 7.

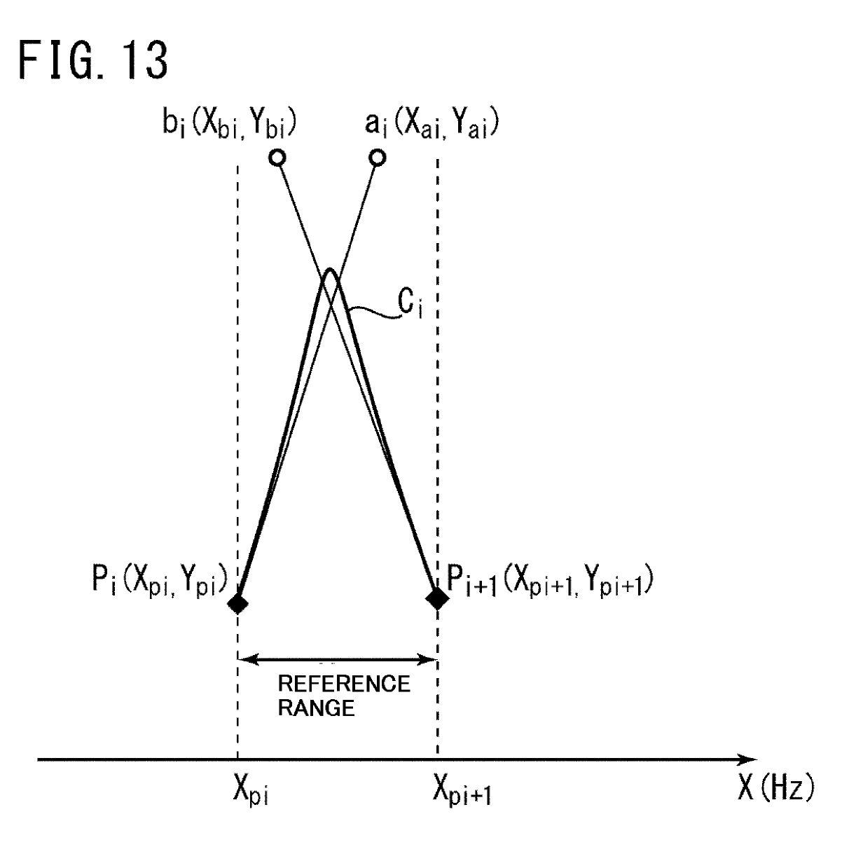

At first, a reason why the intersection reference processing (step S34) is executed will be described. FIG. 13 is a diagram illustrating the Bezier curve Cᵢ in a case where the frequency Xₐᵢ is higher than the frequency X_{bi}. Both the frequencies Xₐᵢ and X_{bi} are present within the reference range, but the frequency Xₐᵢ is higher than the frequency X_{bi} as shown in FIG. 13. In this case, since the Bezier curve Cᵢ draws a sharp peak, an audio with a specific frequency might be enhanced or attenuated despite of the intention of a user. As a result, it is considered that a user feels uncomfortable about an audio output from the speaker 14. The intersection reference processing (step S34) is executed so that a frequency response curve does not have a shape unintended by the user. Further, the intersection reference processing (step S34) prevents the Bezier curve shown in FIG. 6 from having a shape such that a spiral is drawn and gains of an audio signal cannot be uniquely specified.

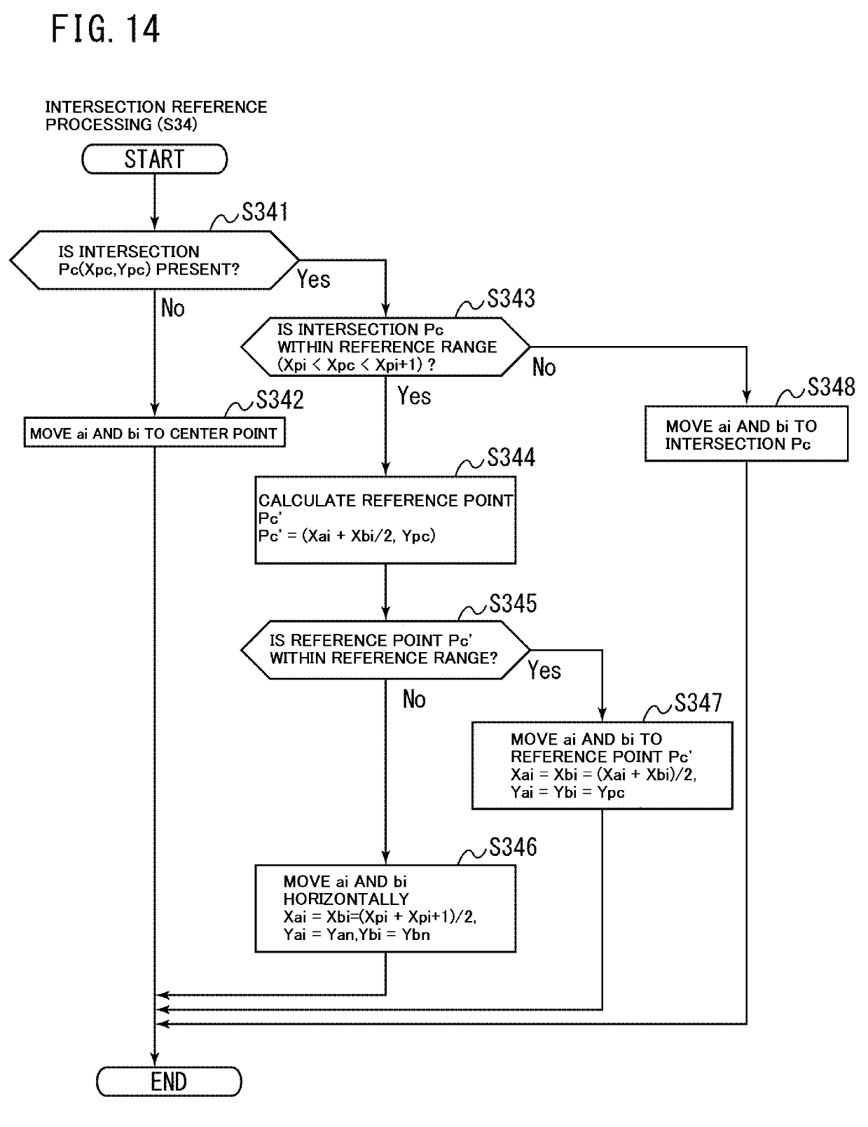

FIG. 14 is a flowchart of the intersection reference processing (step S34). The CPU 11 determines whether the intersection P_{c} is present as a result of step S33 as shown in FIGS. 4, 7, and FIG. 14 (step S341).

When the intersection P_{c} is not present (No at step S341), the tangent Tᵢ is parallel with the tangent Tᵢ₊₁. In this case, the CPU 11 moves the direction points aᵢ and bᵢ to a center point of the direction points aᵢ and bᵢ (step S342). Since the direction point aᵢ matches with the direction point bᵢ, the Bezier curve Cᵢ is a second Bezier curve.

When the intersection P_{c} is present (Yes at step S341), the CPU 11 determines whether a frequency X_{pc} of the intersection P_{c} is within the reference range (step S343). The frequencies Xₚᵢ and Xₚᵢ₊₁ are not included in the reference range at step S343.

When the frequency X_{pc} is out of the reference range (No at step S343), the CPU 11 moves the direction points aᵢ and bᵢ to the intersection P_{c} (step S348). In this case, the Bezier curve Cᵢ becomes a second Bezier curve similarly to step S342.

On the other hand, when the frequency X_{pc} is within the reference range (Yes at step S343), the CPU 11 calculates a reference point P_{c}′ (step S344). The frequency of the reference point P_{c}′ is an average of the frequency Xₐᵢ of the direction point aᵢ and the frequency X_{bi} of the direction point bᵢ. The gain of the reference point P_{c}′ matches with the gain of the intersection P_{c}. The CPU 11 determines whether the reference point P_{c}′ is within the reference range (step S345). The frequencies Xₚᵢ and Xₚᵢ₊₁ are not included in the reference range at step S345.

When the reference point P_{c}′ is out of the reference range (No at step S345), the CPU 11 moves the direction points aᵢ and bᵢ parallel with a horizontal axis (step S346). Concretely, the CPU 11 moves the direction points aᵢ and bᵢ so that the frequency Xₐᵢ of the direction point aᵢ and the frequency X_{bi} of the direction point bᵢ are the frequency of the reference point P_{c}′. The gains of the direction points aᵢ and bᵢ are not changed. When step S346 is executed, since the gains of the direction points aᵢ and bᵢ are different from each other but the frequencies match with each other, the Bezier curve Cᵢ is still maintained as a third Bezier curve.

On the other hand, when the reference point P_{c}′ is within the reference range (Yes at step S345), the CPU 11 moves the direction points aᵢ and bᵢ to the reference point P_{c}′ (step S347). Concretely, the frequency Xₐᵢ of the direction point aᵢ and the frequency X_{bi} of the direction point bᵢ match with the average of the frequencies Xₐᵢ and X_{bi}, and the gains of the direction points aᵢ and bᵢ match with the gain of the intersection P_{c}. In this case, the Bezier curve Cᵢ becomes a second Bezier curve similarly to step S342.

In such a manner, when the frequency Xₐᵢ is higher than the frequency X_{bi}, the CPU 11 executes the intersection reference processing (step S34), so as to make at least the frequencies of the direction points aᵢ and bᵢ match with each other. As a result, Bezier curve Cᵢ can be prevented from having a sharp peak and from having sound quality that is not intended by the user.

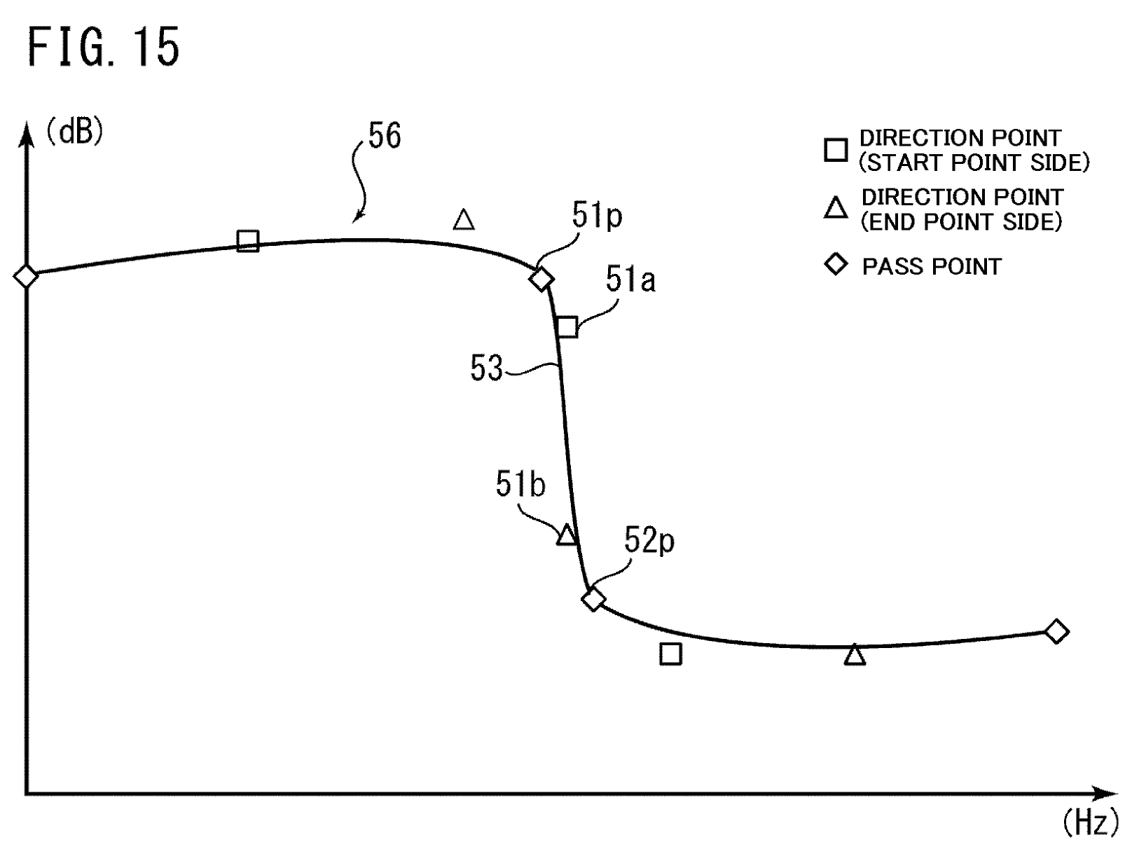

FIG. 15 is a graph illustrating the Bezier curve 53 after the direction points 51a and 51b shown in FIG. 5 are moved by the direction point adjustment processing (step S3).

From FIG. 5 and FIG. 15, it is found that the shape of the Bezier curve 53 changes. This is because the direction points 51a and 51b are moved to be within the reference range in the pass point reference processing (step S31), and the direction points 51a and 51b are moved parallel with the horizontal direction in the intersection reference processing (step S34) (step S346). The direction points except for the direction points 51a and 51b are not moved in the direction point adjustment processing (step S3). The change in the Bezier curve 53 enables the gains to be uniquely specified.

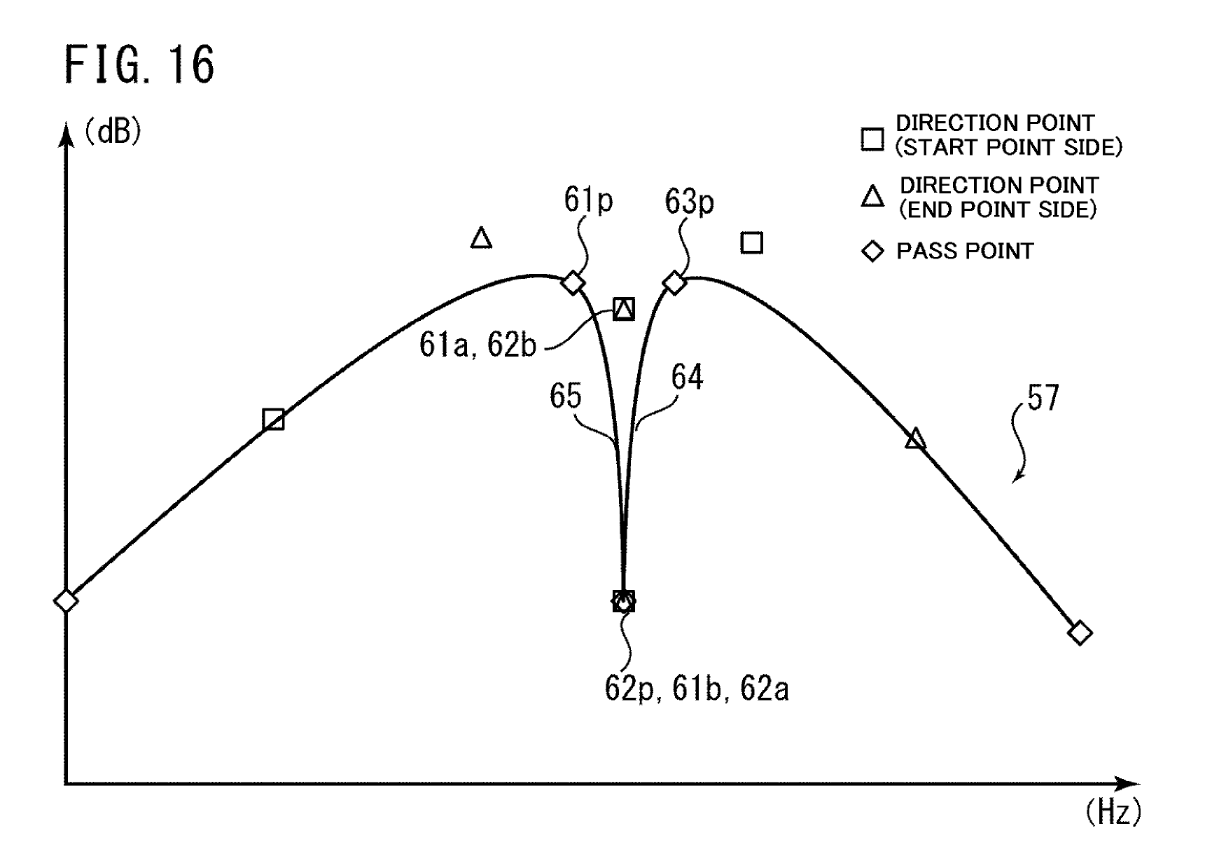

FIG. 16 is a graph illustrating the Bezier curves 64 and 65 after the direction points 61a, 61b, 62a, and 62b shown in FIG. 6 are moved in the direction point adjustment processing (step S3). The direction points 61a, 61b, 62a, and 62b are moved by the direction point adjustment processing (step S3), but the other direction points are not moved.

Since the frequencies of the direction points 61a and 61b are higher than the frequency of the pass point 62p, the direction points 61a and 61b are moved so that the frequencies of the direction points 61a and 61b match with the frequency of the pass point 62p (step S31) as shown in FIGS. 6 and 16. As a result, since the frequencies of the direction points 61a and 61b match with each other (Yes at step S32), the CPU 11 does not execute the intersection reference processing (step S34) on the direction points 61a and 61b.

Since the frequencies of the direction points 62a and 62b are lower than the frequency of the pass point 62p, the direction points 62a and 62b move so that the frequencies of the direction points 62a and 62b match with the frequency of the pass point 62p (step S31). As a result, the frequencies of the direction points 62a and 62b match with each other (Yes at step S32), the CPU 11 does not execute the intersection reference processing (step S34) on the direction points 62a and 62b.

As a result, the frequency response curve 57 is changed into a shape without a loop as shown in FIG. 16. In FIG. 16, the direction point 61a seems to overlap with the direction point 61b, but actually the gains of the direction points 61a and 61b are different from each other. Similarly, the direction points 61b and 62a, and the pass point 62p seem to overlap with one another, but actually, the gains of the direction points 61b and 62a, and the pass point 62p are different from one another. The frequency response curve 57 has a peak whose lower limit is the pass point 62p. However, since the pass points 61p to 63p are set so that the pass point 62p is the peak of the lower limit, it is considered that the user has less chance of feeling uncomfortable about sound quality of an audio signal.

The above embodiment describes the example in which the determination program 21 includes the pass point reference processing (step S31) and the intersection reference processing (step S34) in the direction point adjustment processing (step S3), but the present invention is not limited to this. The determination program 21 may be a program for executing only any one of the pass point reference processing (step S31) and the intersection reference processing (step S34).

The above embodiment describes the example in which when the CPU 11 executes the pass point reference processing (step S31: see FIG. 8), it moves the direction point aᵢ in the direction of the tangent Tᵢ, and moves the direction point bᵢ in the direction of the tangent Tᵢ₊₁, but the present invention is not limited to this. The CPU 11 may move, for example, the direction points aᵢ and bᵢ parallel with the horizontal axis. Further, the example in which the direction point aᵢ is moved so that the frequency Xₐᵢ matches with any one of the frequencies Xₚᵢ and Xₚᵢ₊₁ is described, but the present invention is not limited to this. After the movement of the direction point aᵢ, the frequency Xₐᵢ may be not less than the frequency Xₚᵢ and not more than the frequency Xₚᵢ₊₁. That is to say, when the determination is made that the frequency Xₐᵢ of the direction point aᵢ is out of the reference range, the CPU 11 may move the direction point aᵢ so that the frequency Xₐᵢ is within the reference range in the pass point reference processing (step S31). Much the same is true on the direction point bᵢ.

The embodiment describes the example in which the CPU 11 makes the frequencies Xₐᵢ of the direction point aᵢ match with the frequencies X_{bi} of the direction point bᵢ in the intersection reference processing (step S34), but the present invention is not limited to this . The CPU 11 may move any one of the direction point aᵢ and the direction point bᵢ so that the frequency Xₐᵢ of the direction point aᵢ is not more than the frequency X_{bi} of the direction point bᵢ. As a result, the Bezier curve Cᵢ can be prevented from drawing an extremely sharp peak.

The embodiment describes the example in which the determination program 21 is installed into the tablet terminal 1, but the present invention is not limited to this. The determination program 21 may be installed into computers such as laptop personal computers, smartphones, and mobile telephones. As a result, these computers can be used as the frequency characteristics determination device.

The above embodiment describes the example in which the determination program 21 is installed into the tablet terminal 1. A method for installing the determination program 21 is not particularly limited. For example, the determination program 21 may be downloaded from a server connected to a network, and installed into the tablet terminal 1. When a medium readable by a computer into which the determination program 21 is recorded (for example, an optical disc, an USB (Universal Serial Bus) memory, a flexible disc or the like) is distributed, the determination program 21 may be installed from the medium into the tablet terminal 1.

The embodiment of the present invention is described above, but the embodiment is only an example for carrying out the present invention. Therefore, the present invention is not limited to the above embodiment, and can be carried out by suitably modifying the above embodiment without deviating from the gist.

What is claimed is:

1. A frequency characteristics determination device comprising:
a setting section for setting a first pass point through which a frequency response curve of an audio signal should pass, and a second pass point whose frequency is higher than a frequency of the first pass point;
a determination section for determining one or more direction points of a Bezier curve connecting the set first and second pass points based on the set first and second pass points;
a range determination section for determining whether frequencies of the one or more direction points determined by the determination section are within a range between not less than the frequency of the first pass point and not more than the frequency of the second pass point;
a moving section for moving the one or more direction points so that frequencies of the direction points are within the range when the determination is made that the frequencies of the direction points are out of the range;
a generation section for generating a Bezier curve based on the one or more direction points and the first and second pass points; and
a changing section for changing the frequency response curve of the audio signal according to the Bezier curve generated by the generation section.

2. The frequency characteristics determination device according to claim 1, wherein
the one or more direction points include first and second direction points,
the range determination section determines whether each of the first and second direction points is within the range.

3. The frequency characteristics determination device according to claim 2, wherein
a first tangent of the Bezier curve at the first pass point passes through the first direction point,
a second tangent of the Bezier curve at the second pass point passes through the second direction point, and
the moving section moves the first direction point along the first tangent, and moves the second direction point along the second tangent.

4. The frequency characteristics determination device according to claim 2, wherein
when the frequency of the first direction point is lower than the frequency of the first pass point, the moving section makes the frequency of the first direction point match with the frequency of the first pass point, and when the frequency of the second direction point is lower than the frequency of the first pass point, the moving section makes the frequency of the second direction point match with the frequency of the first pass point, and when the frequency of the first direction point is higher than the frequency of the second pass point, the moving section makes the frequency of the first direction point match with the frequency of the second pass point, and when the frequency of the second direction point is higher than the frequency of the second pass point, the moving section makes the frequency of the second direction point match with the frequency of the second pass point.

5. The frequency characteristics determination device according to claim 2, further comprising:
a comparing section for comparing the frequency of the first direction point with the frequency of the second direction point,
wherein when the comparing section determines that the frequency of the first direction point is higher than the frequency of the second direction point, the moving section moves at least one of the first and second direction points so that the frequency of the first direction point is not more than the frequency of the second direction point.

6. A frequency characteristics determination device comprising:
a setting section for setting a first pass point through which a frequency response curve of an audio signal should pass, and a second pass point whose frequency is higher than a frequency of the first pass point;
a determination section for determining first and second direction points of a Bezier curve connecting the set first and second pass points based on the set first and second pass points;
a comparing section for comparing a first frequency of the first direction point through which a tangent of the Bezier curve at the first pass point passes with a second frequency of the second direction point through which a tangent of the Bezier curve at the second pass point passes;
a moving section for, when the comparing section determines that the first frequency is higher than the second frequency, moving at least one of the first and second direction points so that the first frequency is not more than the second frequency;
a generation section for generating a Bezier curve based on the first and second pass points and the first and second direction points; and
a changing section for changing the frequency response curve of the audio signal according to the Bezier curve generated by the generation section.

7. A recording medium in which a control program is stored, the control program allowing a computer installed into a frequency characteristics determination device to execute:
a step of setting a first pass point through which a frequency response curve of an audio signal should pass and a second pass point whose frequency is higher than a frequency of the first pass point;
a step of determining one or more direction points of a Bezier curve connecting the set first and second pass points based on the set first and second pass points;
a step of determining whether frequencies of the determined one or more direction points are within a range between not less than the frequency of the first pass point and not more than the frequency of the second pass point;
a step of moving the one or more direction points so that frequencies of the one or more direction points are within the range when the determination is made that the frequencies of the one or more direction points are out of the range;
a step of generating a Bezier curve based on the one or more direction points and the first and second pass points;
a step of changing the frequency response curve of the audio signal according to the generated Bezier curve.

8. A recording medium in which a control program is stored, the control program allowing a computer installed into a frequency characteristics determination device to execute:
a step of setting a first pass point through which a frequency response curve of an audio signal should pass and a second pass point whose frequency is higher than a frequency of the first pass point;
a step of determining first and second direction points of a Bezier curve connecting the set first and second pass points based on the set first and second pass points;
a step of comparing a first frequency of the first direction point through which a tangent of the Bezier curve at the first pass point passes with a second frequency of the second direction point through which a tangent of the Bezier curve at the second pass point passes;
a step of, when a determination is made that the first frequency is higher than the second frequency, moving at least one of the first and second direction points so that the first frequency is not more than the second frequency;
a step of generating a Bezier curve based on the first and second pass points and the first and second direction points; and
a step of changing the frequency response curve of the audio signal according to the generated Bezier curve.
